(19) United States
(12) Patent Application Publication
(10) Pub. No.: US 2003/0152907 A1
(43) Pub. Date: Aug. 14, 2003

(54) Process of love

(76) Inventor: George Knauer III, Naples, FL (US)

Correspondence Address: Merrill N. Johnson, 800 Harbour Drive, Naples, FL, 34103, US

(21) Appl. No.: 10/073,093

(22) Filed: Feb. 12, 2002

(51) Int. Cl. G09B 25/00

(52) U.S. Cl. 434/365

(57) ABSTRACT

This invention combines God's gift of reincarnation with love resulting in immortality.

### SUMMARY OF THE INVENTION

This invention resulted from my combining God's gift of reincarnation with love.

In Chapter 4 of the London translation of the Holy Bible, paragraph 8 says “He that loveth not knowth not God; for God is love.” and paragraph 16 says “And we have known and believed the love that God hath to us. God is love; and he that dwelleth in love dwelleth in God, and God in him.”

The scope and extent of my invention is defined in the following claim:

1. The process of combining God's gift of reincarnation with love resulting in immortality.

1. The process of combining God's gift of reincarnation with love resulting in immortality.
